(19) United States
(12) Patent Application Publication
(10) Pub. No.: US 2005/0155839 A1
(43) Pub. Date: Jul. 21, 2005

(54) Efficient battery powered electronic parking meter

(75) Inventors: Ken Banks, Dartmouth (CA); Rob Edsall, Halifax (CA); Allan MacDonald, Dartmouth (CA); George MacKay, New Glasgow (CA)

Correspondence Address: Norman P. Soloway;HAYES SOLOWAY P.C., 130 W. Cushing Street, Tucson, AZ, 85701, US

(73) Assignee: J.J. MACKAY CANADA LIMITED

(21) Appl. No.: 10/846,169

(22) Filed: May 13, 2004

Related U.S. Application Data
(60) Provisional application No. 60/537,039, filed on Jan. 20, 2004.

(51) Int. Cl. G07D 7/00

(52) U.S. Cl. 194/302

(57) ABSTRACT

The electronic parking meter includes a microcontroller, an input interface, an output interface, communications devices and a power supply. The microcontroller receives instructions through the input interface from a user wishing to purchase parking time, controls the output interface to provide parking related messages or indications, and controls the electronic parking meter's communications with other devices through the communications devices for transmitting and receiving information and data. The power supply, which converts a battery pack voltage up to the operating voltage, may include an isolation transformer and a flyback switcher. The parking meter is maintained in a sleep mode as a default state, is placed in a schedule wake-up mode at a predetermined frequency for a predetermined short period of time to carry-out maintenance functions, and is only placed in an event wake-up mode for the time required to process major events, such as coin chute, card reader or communications port interrupts. The maintenance-free life of the parking meter is extended by using more of the energy that is available in standard battery packs and by decreasing energy consumed in the parking meter to carry out its functions through the three operating modes including the periodic schedule wake-up mode.

This application claims the benefit of U.S. Provisional Patent Application Ser. No. 60/537,039 filed on Jan. 20, 2004.

### FIELD OF INVENTION

The present invention relates generally to single space electronic parking meters, and more particularly to an energy efficient electronic parking meter.

### BACKGROUND OF THE INVENTION

Parking authorities continue to look to the use of single space parking meters as a source of revenue from both on street parking as well as parking in unattended parking lots. However, in addition, these parking spaces are also used to entice car drivers to certain areas of a city by allowing parking for limited periods of time thus assuring the availability of parking. Therefore parking meters must be convenient, easy to operate and very versatile in terms of the variety and clarity of the messages that they display.

In order to respond to such a need, electronic parking meters have been developed. Examples of such parking meters are the Watchman® and the Guardian® electronic parking meters by J.J. MacKay Canada Ltd. These meters are operated by microcontrollers, which control the input interfaces for a user to purchase parking time, output interfaces to provide a user with information such as unexpired parking time and communications ports for uploading information to the meters and downloading audits from the meters. The Watchman® input interface includes a coin chute whereas the Guardian® also includes a smart card reader. The output interfaces include LCD's with various parking related messages and LED's for visual status information such as parking time paid, meter expired, meter out of service.

These electronic parking meters are normally stand alone meters and are powered by battery. The requirements of parking authorities place a number of constraints on the powering of the parking meters. They wish to use standard batteries to keep the cost of batteries and battery replacement down and to use a battery type compatible with their existing meters. In addition, the space within the meter housing limits the size and thus the power storage capacity of the battery. Present electronic parking meters operate in the order of one year before battery replacement is necessary.

In spite of these advances, it is still desirable to have stand alone parking meters that will operate for longer periods of time to avoid the high maintenance costs incurred to replace the batteries in the large numbers of individual parking meters. In addition, with space limiting the size and thus the energy storage of a battery, the only gains that can be made in present electronic parking meters are through the use of much more expensive batteries.

Therefore, there is a need for an improved electronic parking meter that is more energy efficient.

### SUMMARY OF THE INVENTION

The invention is directed to an electronic parking meter wherein components are adapted to operate at a predetermined voltage, The electronic meter comprises an input interface for receiving payment for parking time, an output interface for displaying parking related messages, a microcontroller for controlling the input interface and the output interface, and a power supply adapted to convert an input voltage from below the operating voltage to the predetermined operating voltage of the components to power the electronic parking meter. The power supply may be an isolation transformer power supply and may further be adapted to convert input voltages from above the operating voltage to the predetermined operating voltage. The voltage supply may also include a flyback switcher wherein the supply voltage is provided by a battery that may be permanently fixed to the flyback switcher input.

In accordance with another aspect of the invention, the input interface comprises a smart coin chute having an analog circuit sensor that senses coins within the chute and an A/D converter that receives analog coin signals from the analog sensor, converts the analog coin signals to digital signals, and transmits the digital signals to the meter microcontroller. The input interface may further include a smart card reader adapted to transmit smart card digital information to the meter microcontroller.

In accordance with a further aspect of this invention, the output interface comprises one or more LCD's adapted to display parking related messages. The LCD's may have a front LCD and a back LCD having a number of similar or different message elements that are controlled by the microcontroller, the microcontroller includes paging units for controlling the activation of the parking related messages on the LCD's individually in ON/OFF or blinking modes. A backlight may be positioned relative to the front and the back LCD's to enhance the visibility of the parking related messages

In accordance with yet another aspect of the invention, the output interface comprises one or more LED's adapted to indicate status of the parking meter. The microcontroller is adapted to control the LED's to blink at a predetermined rate for a variable duration.

In accordance with a further aspect If this invention, the parking meter may include one or more communications ports for receiving information from outside the parking meter and/or transmitting information from the parking meter. The communications ports may include one or more of the following: an IrDA port, an RF port, a card edge connector, an expansion port and a card reader port.

In accordance with another aspect of the invention, the parking meter includes a real time clock calibrated to minimize error at a predetermined temperature and adapted to be periodically recalibrated to compensate for temperature variation from the predetermined temperature. The real time clock may comprise a crystal clock having a fixed frequency, a basic timer coupled to the crystal clock for outputting signals at a frequency lower than the fixed frequency and a counter for counting the basic timer signals for providing an output signal equivalent to a period of time to increment the real time clock. The basic timer frequency may be substantially 64 hz and the increment period of time may be substantially one second.

In accordance with a further aspect of the invention, the microcontroller may include a temperature sensor for sensing the environment of the microcontroller.

The present invention is further directed to a method of controlling an electronic parking meter, which comprises maintaining the parking meter in a sleep mode as a default state, placing the parking meter in a schedule wake-up mode at a predetermined frequency for a predetermined short period of time to carry-out maintenance functions, and placing the parking meter in an event wake-up mode for the time required to process major events as they occur. The method may include displaying parking related messages and generating a basic timer signal having a predetermined frequency during the sleep mode. The basic timer signal is applied to a processor in the parking meter for placing the parking meter in the schedule wake-up mode, for applying the basic timer signal to a real time clock to increment the clock and for adjusting the incrementation of the clock by a temperature variation factor. During the schedule wake-up mode, the proper status of displayed parking related messages is verified, payment devices and/or communications ports may be polled.

In accordance with another aspect of the invention, the voltage of a battery pack in a power supply for the parking meter may be measured and compared to a low battery threshold voltage for the power pack. Further the low battery threshold voltage may be adjusted as a function of the temperature of the environment of the battery pack.

In accordance with a further aspect of the invention, the parking meter, in the event wake-up mode, processes a request from a major event device such as a coin chute, a card reader or a communications port, after receiving an interrupt signal from the major event device.

The present invention is further directed to a method of controlling an electronic parking meter operated by a battery pack wherein the battery pack has a nominal low voltage threshold. The method comprises periodically sensing the temperature of the battery environment at a first predetermined rate, adjusting the nominal low voltage threshold as a function of the temperature, periodically sensing the real time voltage of the battery pack at a second predetermined rate, comparing real time voltages of the battery pack to the adjusted low voltage thresholds in real time, and providing a battery low voltage signal when the real time voltage of the battery is below the adjusted low voltage threshold over a predetermined number of comparisons. Regarding a specific aspect of this method, the first and the second predetermined rates may be substantially equal and the nominal low voltage threshold may be adjusted upward with a decrease in temperature and adjusted downward with an increase in temperature.

The present invention is further directed to a method of replacing a battery pack having a predetermined voltage in a battery operated electronic parking meter having a flyback switcher power supply and a meter operating software. The method comprises removing the battery pack to be replaced from the meter, connecting a further battery pack to the meter, measuring the voltage of the further battery pack, and comparing the voltage of the further battery pack to the predetermined voltage. The method further comprises downloading operating parameters corresponding to the further battery pack to the electronic parking meter when the voltage of the further battery pack is not equal to the predetermined voltage.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a schematic of a basic electronic parking meter;

FIG. 2 is an embodiment of the electronic parking meter in accordance with the present invention;

FIG. 3 illustrates the operation of a real time clock in accordance with the present invention; and

FIG. 4 illustrates the operating modes of the present invention.

### DETAILED DESCRIPTION

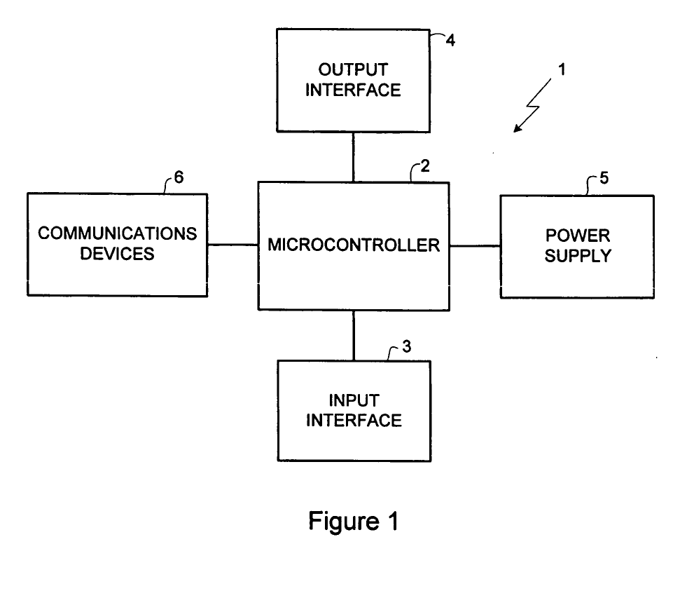

Electronic parking meters 1, as illustrated in FIG. 1, basically include a microcontroller 2, an input interface 3, an output interface 4, communications devices 6 and a power supply 5. The microcontroller 2 receives instructions through the input interface 3 from a user wishing to purchase parking time, controls the output interface 4 to provide parking related messages or indications, and controls the electronic parking meter's communications with other devices through the communications devices 6 for transmitting and receiving information and data. In addition, the electronic parking meter 1 is powered by a power supply 5, which normally uses a battery pack as a power source.

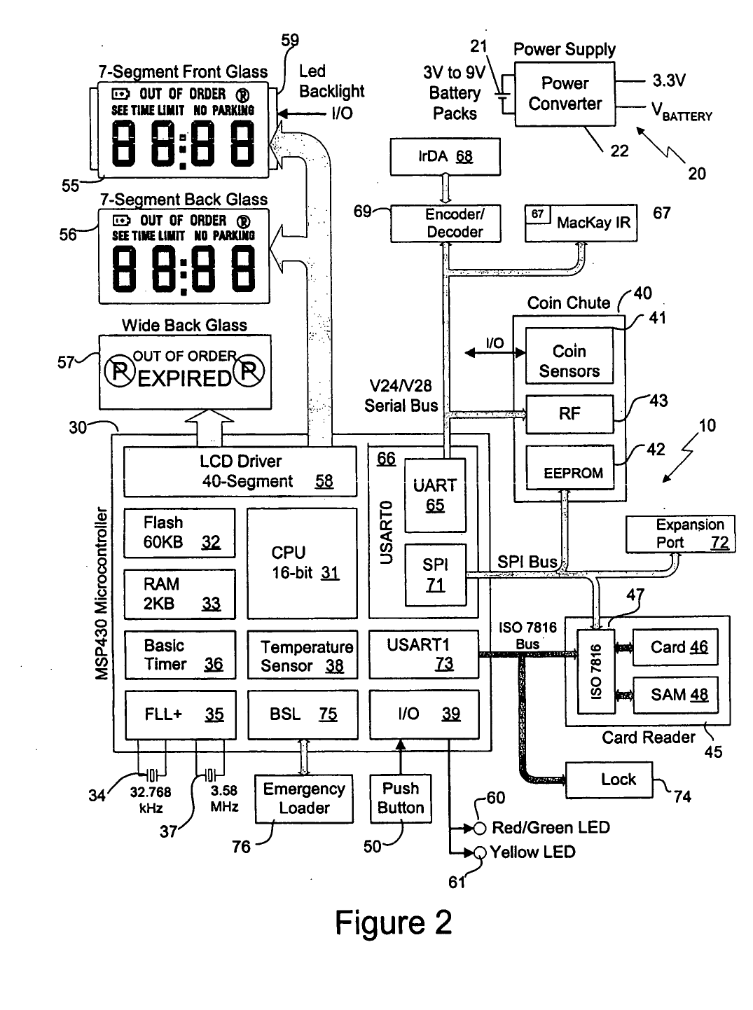

FIG. 2 illustrates an embodiment of the electronic parking meter 10 in accordance with the present invention. In the present embodiment, the components of the electronic parking meter 10 have virtually all been selected to operate from a 3.3 volt power supply 20 in order to contribute to the energy efficiency of the parking meter 10, rather than the 5 volt systems used in prior electronic parking meters. This is particularly advantageous since the energy savings are in the order of the square of the amount of voltage reduction. Therefore, as advances are made in processors and other components, operating voltages lower than 3.3 volts are possible and desirable within the scope of the present invention.

The power supply 20 in accordance with the present invention uses a battery or battery pack 21 as its power source and a power converter 21 that is capable of providing the required output voltage of 3.3 volts whether the battery 21 is delivering a voltage that is below or above the 3.3 volts. Batteries 21 commonly used in electronic parking meters are the standard 9 volt cell or four 1.5 volt AA cells connected as a power pack providing 6 volts; the voltages that the batteries 21 deliver however degrade with time and usage. It is therefore an efficient use of battery capacity to have the power supply 20 continue to provide the required operating voltage of 3.3 volts even after the battery 21 delivers a voltage of less then 3.3 volts. Various power converter 22 arrangements may be used with the present invention. In discussing these arrangements, reference will be made to the Artesyn Power Application Manual, Chapter 1: Principles of Power Conversion, pages 1-17, Artesyn Technologies, which may be found on the website: www.artesyn.com/powergroup/power_applications_library.htm and which is incorporated herein by reference.

One type of power converter 22 that may be used is a flyback converter illustrated in FIG. 1.8 on page 8 of the above referenced publication. The converter has an isolating transformer that provides isolation between its input and its output such that the input voltage will be stepped-up or stepped-down as required to provide the predetermined output voltage. Converter 22 is fed by a battery pack 21 having a nominal voltage of 3 to 9 volts and provides a regulated output voltage of 3.3 volts. Thus, the electronic parking meter 10 can use low voltage, high capacity batteries to operate, and will run for longer periods of time without battery maintenance.

A further, preferred type of power converter 22 includes a boost regulator followed by a linear regulator. The boost regulator will step-up the battery voltage to some desired voltage level above the operating voltage of 3.3 volts and the linear regulator will provide a regulated output voltage of 3.3 volts. This arrangement is particularly advantageous in that the boost regulator may be controlled to simply pass through the input voltage from the battery if it is already greater then the desired voltage level and the regulator would then regulate this voltage top provide an output voltage of 3.3 volts; this arrangement provides a power converter 22 with low power losses. The boost regulator and the linear regulator may be of the type illustrated in FIG. 1.7 and FIG. 1 respectively in the above referenced publication.

The power converter 22 provides a regulated output of 3.3 volts using a wide range of input voltages such as 2 volts to 12 volts. Though the above power supplies have been described as providing a regulated output of 3.3 volts, it is clear that these power supplies may be adapted to provide other voltage outputs such as voltages lower than 3.3 volts if required.

The electronic parking meter 10 includes a microcontroller 30, which is used to control its operations. The microcontroller 30 comprises a number of components that populate a printed circuit board (PCB) (not shown). It has been found to be particularly advantageous to have all of the components located on one side, the front side, of the PCB so that there is sufficient space on the backside of the PCB for the battery pack 21.

The microcontroller 30 comprises a processor (CPU) 31 associated with a flash memory 32 and a random access memory (RAM) 33. CPU 31 may be a Texas Instruments—MSP430F449 processor or any other type of similar processor operating at 3.3 volts. The flash memory 32 is a rewritable memory in which is stored the electronic parking meter 10 software and operating parameters. The RAM 33 is a fast read-write memory for the temporary storage of variables and the like during software processing.

The microcontroller 30 clocking system is basically controlled by a 32.768 kHz crystal clock 34, which drives frequency locked loop (FLL) 35 to provide an output having a frequency of 7.3 MHz, the operating frequency for the CPU 31. However, in addition the clock 34 drives a basic timer 36 that is used to periodically wake-up the CPU 31 from its low power or sleep mode as well as to control the CPU 31 to produce a real time clock as will be described below. In this particular embodiment, the basic timer provides a 64 hz output signal. A further 3.58 MHz crystal clock 37, which is normally powered off, is also adapted to be coupled to FLL 35. Clock 37 is powered up, when required, to provide an appropriate clock for a card reader to be described below. In this situation, clock 34 continues to be coupled to basic timer 36 to provide the 64 hz signal.

The microcontroller 30 includes a temperature sensor 38, which measures the actual temperature of the environment of the microcontroller 31 of the parking meter. The temperature sensor 38 is polled periodically to log the temperature of the meter. The temperature may be logged in flash memory 32. As will be described below, the temperature reading may be used for a number of purposes such as to adjust a real time clock, to modify the operation of LCD's, to compensate for battery power level fluctuation due to temperature change and to compensate coin sensors in a coin chute. Though it has been determined that a polling rate in the order of once per hour appears to be sufficient for most of these purposes, other polling rates may also be used.

The parking meter 10 has input and output interfaces 39 that may include a number of devices. A standard input device for parking meters 10 is a coin chute 40, which receives coins inserted into a coin slot in the meter 10 housing and which, using coin sensors 41, recognizes the coins. One form of coin chute is described in U.S. Pat. No. 6,227,343 issued on May 8, 2001, which is incorporated herein by reference. The coin chute 40 is normally in the sleep mode, however CPU 31 under the control of the basic timer 36, periodically polls the coils in the coin sensors 41 to determine if a coin is dropping through the chute 40. Coin chute 40 is somewhat modified from the chute described in the above patent regarding the hardware for processing information. Rather than include a processor within the coin chute, the present coin chute 40 performs an analog to digital conversion to digitize the information generated by the coin sensors 41; the digitized information is transmitted to CPU 31 through the I/O 39 where it is processed to determine the time purchased by a user. The coin transaction information is also stored in the electrical erasable programmable read only memory (EEPROM) 42. This audit information will therefore remain with the chute 40 if it is removed for maintenance or for insertion into another meter. It is noted that energy savings are achieved by having the CPU 31 process the information for the chute 40 rather than have a processor incorporated in the chute 40.

The chute 40 can further include an RF communications port 43 that is accessed by inserting an antenna into the coin slot of the coin chute 40 to achieve high speed wireless communications with the meter 10 CPU 31.

An optional input device for the parking meter 10 is a card reader 45 for a smart card 46 that is ISO 7816 compliant. The standard operating voltage for smart cards 40 is 1.8, 3 or 5 volts. Since the power supply 20 output voltage is 3.3 volts, the ISO 7816 interface 47 is used to step up the supply voltage to 5 volts or step down the voltage to 1.8 or 3 volts. As with the coin chute 40, the card reader 45 is normally in the sleep mode consuming insignificant amounts of power. However, in the case of the card reader 45, a mechanical switch causes an interrupt when a card 46 is inserted into the reader 45. CPU 31 thus interrogates the card reader 45 through ISO 7816 interface 47 to determine the operating voltage of the card and than starts the routine for payment by smart card 46.

With the addition of a SAM socket 48, the parking meter 10 is able to validate the money on the card 46 and decode information through decryption algorithms and keys, which are stored on the SAM 48. Using a SAM 48, the meter 10 will be able to accept higher level card systems, may take money off of the card and store it in the SAM 48 itself or in memory 32. This money data may than be taken from the SAM 48 or the memory 32 through an audit.

Card reader 45 purchase interfaces fall into two standard groups. The first is a buttonless approach. A card 46 is inserted into the card reader 45 and after the card 46 is identified and read, parking time is incremented automatically on the parking meter 10, i.e. the longer a card is left in the reader 45 the greater the amount of time has been purchased. Thus a user has to watch the time increment on the meter 10 and then remove the card 46 when the desired amount of time is reached. In the second approach, the card 46 is identified and read in the same manner as the first, however in this case the user must manually increment the time desired on the meter 10. This is accomplished by having the user push a button 50. Thus the time increments with every push of the button 50, allowing the user greater control.

The parking meter 10 output devices provide visual indications of the status of the meter 10 as well as the unexpired parking time available. These output devices comprise LCD's and LED'S. The LCD's include a front glass LCD 55 and a back glass. The back glass is optionally an LCD 56 of the front glass type or an enforcement LCD 57. LCD's 55 and 56 operate in parallel to provide the same information through 7 segment numbers/letters and through icons such as “out of order”, “coins only”, “cards only”, “low battery”, “expired”, “no parking”, “see time limit”, and the like. The back LCD 57 includes icons such as “no parking”, “expired”, “out of order” and can also display an entirely filled LCD 57 as a red flag indicating that there is no paid parking time on the meter 10. The LCD's 55 and 56, as well as LCD 57, are controlled by LCD driver 58. In addition, an LED backlight 59 is positioned such that light is piped behind the front glass of the LCD's 55 and 56 to light up the LCD's particularly during transactions at night so that the unexpired time and icons are visible to a user.

The control of LCD's in prior electronic meters, which are hardware based, are normally capable of being totally ON, totally OFF or blinking at a predetermined frequency of 1 hz or 2 hz, which is the norm. However, the individual elements, icons and numbers/letters, of each LCD always blink in phase with one another, thus being ON or OFF together. The elements on the present LCD's 55 and 56 or 57 can be individually controlled by CPU 31 to blink in phase, totally out of phase or even partially out of phase with one another. This is achieved by controlling the drivers 58 using a paging method whereby each page, which has a predetermined duration in the order of ¼ second, will determine which LCD elements are ON or OFF. The programmed routine could consist of eight control pages that are displayed sequentially and continuously cycled. Each page can be adapted to control all of the elements individually on each LCD.

It has been found that LCD's do not respond well to cold temperatures in that once the temperature reaches a predetermined low level, for example in the order of −20° C., there is a delay before an LCD will turn ON. Any icons or numbers/letters, which are being controlled to blink, will appear dim or even OFF in this cold temperature state. When the temperature sensor 38 detects that the temperature of the parking meter 10 is below this predetermined level, the LCD's will be controlled to remain ON continuously thus being more visible to a user.

The LED's 60 and 61 are particularly used to assist a user or a parking authority attendant to determine, from a distance, whether the parking meter 10 is expired or not. LED 60 is typically controlled to flash red when the parking meter 10 is expired and flash green when there is paid parking time on the meter 10. LED 61 may be made to flash yellow if the battery 21 is low or if the meter 10 is out of service for some reason. The industrial standard for blinking LED's is ½, 1 and 2 hz. In accordance with the present invention, the LED's 60, 61 are further controlled to be capable of varying their duty cycle in the order of 3 to 8 ms per second. It is desirable for an LED to be brighter in the daytime than at night such that it visible at a distance. This can be achieved by varying the pulse width of the time the LED is ON. As the pulse width increases, the brightness increases and as the pulse width decreases, the brightness decreases. However, in order not to expend more energy during the day to power the LED's, the frequency of the blink may be varied inversely to the pulse width by reducing the frequency of the blinking LED, resulting in stable energy consumption of the LED's 60, 61 over time.

The parking meter 10 may include a number of ways of communicating with parking authority agents or other authorized personnel to audit the parking meter 10 or to download or upload information and/or programming.

As discussed above, high-speed communications may be achieved through the RF sensor 43 in the coin chute 40. The RF sensor 43 is coupled through the universal asynchronous receive transmit communications section (UART) 65 of the universal synchronous asynchronous receive transmit communications module (USART) 66. In addition, the same module 66 may be used for infrared communications. To this end, an infrared port 67 is coupled to UART 65 for exchanging signals with a MacKay IR device, a proprietary communications system. However, since MacKay IR is relatively slow, approximately 2 kb/sec, and consumes substantial power, a standard IrDA system, which communicates at approximately 115 kb/sec may be preferred. An IrDA port 68 is followed by an encoder/decoder 69, which in turn is coupled to the UART 65. The synchronous module 71 SPI bus is used to control the EEPROM 42 and ISO 7816 47 interface as well as support an expansion port 72. Expansion port 72 may be any type of high-speed port such as an RJ port or a card edge port. Expansion port 72 may also be coupled to an 12C bus from the I/O device 39. It is noted that the high speed communications ports, such as the expansion port 72, the RF port 43 and the smart card reader could operate up to 2 Mb/sec.

In operation, the MacKay IR port or the IrDA port is normally in the sleep mode. These ports are polled periodically, such as once per second, to determine if an IR device is attempting to communicate with the meter 10.

A second universal synchronous asynchronous receive transmit communications module (USART) 73 is used to transmit data to and from the card reader 45 through the ISO 7816 interface 47, as well as to and from an optional electronic lock 74. Thus access to the parking meter 10 may be controlled since a smart key has to be properly mechanically coded as well as logically coded before access is allowed. In addition, each entrance event is recorded in memory 32.

The parking meter 10 further includes an emergency loading port (BSL) 75, which only permits writing to the memory 32, this course of action is usually only taken if the software in the memory is corrupted, thus preventing program uploads by any of the other communications ports. This can only be achieved through the use of an emergency loader 76 wired to the BSL 75.

In addition to the crystal clock 34 and the basic timer 36, the CPU 31, through programming, maintains a virtual real time clock 80 that is cumulative. It is important to have an accurate real time clock 80 since many of the functions of a parking meter 10 are time dependent, whether on an hourly, daily, weekly or even seasonal basis. Since a parking meter 10 may not need any maintenance, battery or otherwise, done over a period that could extend into years, the real time clock 80 should remain accurate to within a matter of seconds.

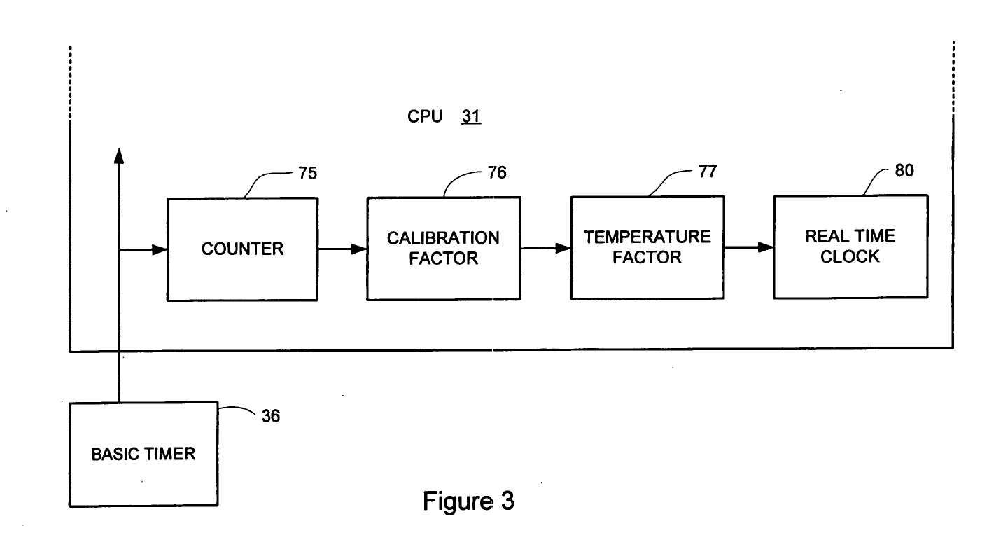

As illustrated in FIG. 3, the real time clock 80, which is set when the meter 10 is placed in service, is driven by a counter 75 that counts the wake-up signals received from the basic timer 36. After every 64 signals, the real time clock 80 is incremented by one second, since the basic timer 36 has a frequency of 64 hertz. However, because the frequency of all crystal clocks 34 have some deviation from their nominal frequency, it is necessary to recalibrate the real time clock 80 by a calibration factor 76, which is established before the parking meter 10 is placed into service. In order to determine the calibration factor 76, the crystal clock 34 is compared to a highly accurate standard and the deviation is measured. The ±X percentage deviation from the standard becomes the nominal calibration factor 76, which is used to control the real time clock 80. For example, if the crystal clock 34 is slow, the nominal calibration factor of ±X will be added to the nominal 1 second such that the clock 80 is incremented 1±X seconds after every 64th signal is received by the counter 75 from the basic timer 36 rather than 1.0 seconds thus keeping it accurate over time.

Another factor, which can affect the accuracy of the real time clock 80, is the temperature of the crystal clock 34. The nominal frequency of the clock 34 is determined under set conditions and at a specific temperature. Temperature swings may slow down or speed up the clock 34 slightly, therefore the CPU 31 calculates and applies a further varying temperature calibration factor 77 based on the temperature measured by the temperature sensor 38.

There are a significant number of advancements in the operation of the parking meter 10 in accordance with the present invention as will be described below. The amount of energy used by the meter 10 is minimized by using power only when it is needed and in order to accomplish this, it is important to understand the purpose of the parking meter 10, as well as the functions that are carried out by the different components of the meter 10, their frequency of operation and their level of power consumption.

The operation of the parking meter 10 is controlled by the microcontroller 30 through the software and operating parameters stored in the memory 32 and processed by processor 31. The software for parking meter 10 is adapted to operate the meter 10 in order to carry out all of the required functions under divers circumstances. These include the location of the meters, the timetable for parking meter use, as well as, the type of batteries to be used. Therefore for each circumstance, predetermined parameters will be selected to assure the proper operation of the meter 10. For example, the parameters may include the hours when the meters are to be functioning, the hourly rate for parking, the types of coins to be accepted, and the like.

The software that is downloaded into the parking meter 10 must include operating parameters that conform to the battery pack 21 that is to be used with the power supply 20. In order to be sure that the parking meter 10 operates properly, the software can be adapted to shut down the operation of the meter 10 when a battery pack is to be removed for replacement. With the installation of a new battery pack 21 into the electronic meter 10, an installation software, having the proper operating parameters, may be used to revive the meter 10. Alternately, the installation software may automatically select the proper operating parameters from a set of predetermined battery parameters based on the old battery voltage, the new battery voltage and available parameter sets. As an example, the scenario for replacing a meter battery pack having a predetermined voltage may be achieved by removing the battery pack from the meter, connecting a further battery pack to the meter, measuring the voltage of the further battery pack and comparing the voltage of the further battery pack to the predetermined voltage. In this way, if the further battery pack voltage is equal to the predetermined voltage of the original battery pack, the original operating parameters may continue to be used. However, if the voltage of the further battery pack is not equal to the predetermined voltage, new operating parameters that correspond new battery pack may be selected for use in the meter.

Traditionally, the battery packs 21 would either be at 6 or 9 volts, however in view of the versatility of the flyback switcher 20, which can operate with input voltages of 2 to 12 volts, battery packs 21 at other voltage levels may be used. During the operation of the meter 10, the voltage of the battery pack 21 is measured periodically and compared to a predetermined low battery threshold voltage V_{lbt.} V_{lbt} is a voltage level that is established for each type of battery pack 21 as an indication that the battery pack 21 is reaching the end of its useful life in the meter 10. In this particular embodiment, the voltage level is measured in the order of once every hour and compared to V_{lbt}. Every battery pack 21 has its own V_{lbt} depending on the types of batteries in the pack. In prior electronic meters, the V_{lbt} was passive or fixed in that it was set at a nominal value that did not vary during the lifetime of the battery pack 21.

In accordance with the present invention, in order to assure greater reliability of the battery pack 21 and to deplete the battery pack 21 as much as possible, V_{lbt} is dynamic and may vary depending on conditions. For instance, V_{lbt} may be varied by ±ΔV depending on temperature change from the nominal level at which V_{lbt} was set since batteries respond differently at different temperatures. V_{lbt} is adjusted upward as the temperature drops since battery performance decreases with a decrease in temperature, and therefore the threshold must be raised to obtain the same performance. It is to be noted that V_{lbt} is set above the level at which the battery pack 21 is no longer able to provide sufficient power to the meter 10 for it to operate properly thus assuring that the parking authority has sufficient warning before the actual failure of the meter 10.

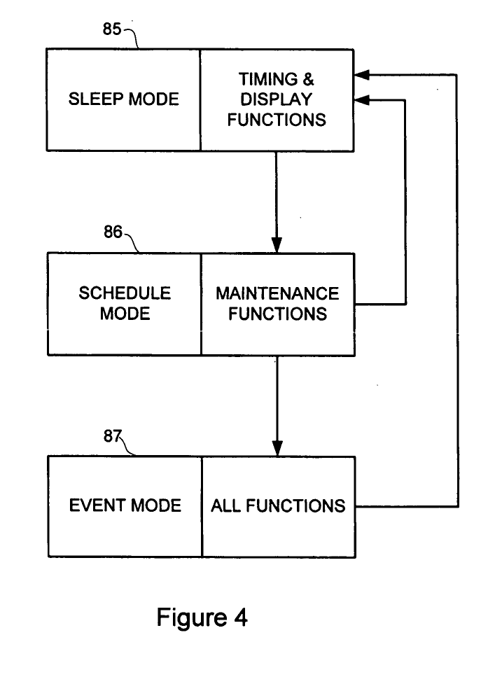

Prior electronic parking meters generally have two states of operation; they are either in a sleep mode when the meter is not operating or a wake mode when the meter is active. The electronic parking meter 10 in accordance with the present invention has three states of operation as shown schematically in FIG. 4. The first or default state is the sleep mode 85 where the use of power is substantially completely avoided. The only components that are operating are the crystal clock 34 and the basic timer 36, which outputs a signal at a frequency of 64 hz as well as possibly one or more output displays such as LCD 55, 56, 59 and LED 60.

The second state of operation is the periodic schedule wake-up mode 86, which occurs when the basic timer 36 sends a signal to the processor 31 every 1/64^{th} of a second or every 15 ms and the meter 10 operates for a short period of time such as 0.1 to 1 ms in order to carry out a schedule of predetermined maintenance operations in addition to the above timing functions. The maintenance operations include assuring the proper status of the LCD's 55, 56, 57 or the LED 60 as well as the polling of the IrDA port 68, the coin chute 40, or all other communications ports 43, 72. It is to be noted that not all of the elements of the meter 10 are polled every 1/64^{th} of a second. For example the battery pack 21 voltage and the temperature are measured every hour, though not necessarily at the same time, the lock 74 and IrDA 20 or MacKay IR and other communications ports are polled every second, while the coin chute is polled every 1/64^{th} of a second. The card reader 45 is not polled since it has a mechanical switch to initiate an event.

The third state of operation is the event wake-up mode 88, which occurs when an interrupt event takes place and takes precedence over all other states. Interrupt events include the card reader 45 detecting a card 46, the coin sensors 41 detecting a coin in the coin chute 40, the activation of the lock 74 or someone attempting to communicate with the parking meter 10 through one of its communications port 68, 67, 72, 43. In the event wake-up mode, the parking meter 10 remains fully awake and performs all functions of the meter 10 until the activity initiated by the event is completed, after which time the parking meter 10 returns to its sleep mode 85.

Though the present invention is described as including an array of components, it is clear that the present invention includes embodiments wherein the meter 10 is not populated with certain of the components such as the card reader 45 and/or various communications ports 43, 67, 68, 72.

Further, in view of the minimal use of energy in the operation of the parking meter in accordance with the present invention, it has been found that battery life can be extended for the entire product life cycle of the parking meter in certain situations. In these cases, it is advantageous to solder the battery onto the printed circuit board with the other meter components and to encapsulate the battery. In this way, connector voltage drops due to corrosion and loose connections are avoided.

The present invention has extended the maintenance-free life of the parking meter in two ways. First the energy available in standard battery packs is increased by reducing the operating voltage of the parking meter and by stepping-up the battery voltage to the operating voltage level. Second, the energy consumption of the parking meter in accordance with the present invention has been decreased by providing a periodic wake-up period for the meter and by budgeting the power consumed for the various functions.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

1. A single space electronic parking meter wherein components are adapted to operate at a predetermined voltage comprising:
an input interface for receiving payment for parking time;
an output interface for displaying parking related messages;
a microcontroller for controlling the input interface and the output interface; and
a power supply adapted to convert an input voltage within a range of voltages from below to above the operating voltage to the predetermined operating voltage to power the electronic parking meter.

2. A single space electronic parking meter as claimed in claim 1 wherein the input interface comprises a smart coin chute, the smart chute comprising:
an analog circuit sensor for sensing coins within the chute;
an analog to digital converter for receiving analog coin signals from the analog sensor, for converting the analog coin signals to digital signals, and for transmitting the digital signals to the meter microcontroller.

3. A single space electronic parking meter as claimed in claim 1 wherein the input interface comprises a smart card reader adapted to transmit smart card digital information to the meter microcontroller.

4. A single space electronic parking meter as claimed in claim 1 wherein the output interface comprises one or more LCD's adapted to display parking related messages.

5. A single space electronic parking meter as claimed in claim 4 wherein the microcontroller includes paging means for controlling the activation of the parking related messages on the LCD's.

6. A single space electronic parking meter as claimed in claim 5 wherein the LCD's comprise a front LCD and a back LCD having a number of message elements.

7. A single space electronic parking meter as claimed in claim 6 wherein the paging means is adapted to control each message element individually.

8. A single space electronic parking meter as claimed in claim 7 wherein each message element is individually controlled to blink.

9. A single space electronic parking meter as claimed in claim 6 wherein the output interface includes a backlight positioned relative to the front LCD to enhance the visibility of the parking related messages.

10. A single space electronic parking meter as claimed in claim 1 wherein the output interface comprises one or more LED's adapted to indicate status of the parking meter.

11. A single space electronic parking meter as claimed in claim 10 wherein the microcontroller includes means for controlling the LED's to blink at a predetermined rate for a variable duration.

12. A single space electronic parking meter as claimed in claim 1 wherein the parking meter comprises one or more communications ports for receiving information from outside the parking meter and/or transmitting information from the parking meter.

13. A single space electronic parking meter as claimed in claim 12 wherein the communications ports comprise one or more of the following: an IrDA port, an RF port, a card edge connector, an expansion port and a card reader port.

14. A single space electronic parking meter as claimed in claim 1 wherein the parking meter includes a real time clock, wherein the microcontroller includes means for applying a calibration factor to the clock to minimize error at a predetermined temperature and wherein the microcontroller includes means for periodically recalibrating the clock to compensate for temperature variation from the predetermined temperature.

15. A single space electronic parking meter as claimed in claim 14 wherein the real time clock comprises:
a crystal clock having a fixed frequency;
a basic timer coupled to the crystal clock for outputting signals at a frequency lower than the fixed frequency;
a counter for counting the basic timer signals for providing an output signal equivalent to a period of time to the real time clock to increment the real time clock.

16. A single space electronic parking meter as claimed in claim 15 wherein the basic timer frequency is substantially 64 hz.

17. A single space electronic parking meter as claimed in claim 16 wherein the increment period of time is substantially one second.

18. A single space electronic parking meter as claimed in claim 1 wherein the microcontroller includes a temperature sensor for sensing the environment of the microcontroller.

19. A single space electronic parking meter as claimed in claim 1 wherein the power supply includes an isolation transformer.

20. A single space electronic parking meter as claimed in claim 1 wherein the power supply includes a flyback switcher.

21. A single space electronic parking meter as claimed in claim 20 wherein the power supply includes a battery permanently fixed to the flyback switcher input.

22. A single space electronic parking meter wherein components are adapted to operate with a predetermined voltage comprising:
an input interface for receiving payment for parking time;
an output interface for displaying parking related messages;
a microcontroller for controlling the input interface and the output interface; and
an isolation transformer power supply adapted to convert an input voltage from below the operating voltage to the predetermined operating voltage to power the electronic parking meter.

23. A single space electronic parking meter as claimed in claim 22 wherein the power supply includes a flyback switcher.

24. A single space electronic parking meter as claimed in claim 23 wherein the power supply includes a battery permanently fixed to the flyback switcher input.

25. A single space electronic parking meter as claimed in claim 22 wherein the input interface comprises a smart coin chute, the smart chute comprising:
an analog circuit sensor for sensing coins within the chute;
an analog to digital converter for receiving analog coin signals from the analog sensor, for converting the analog coin signals to digital signals, and for transmitting the digital signals to the meter microcontroller.

26. A single space electronic parking meter as claimed in claim 22 wherein the output interface comprises one or more LCD's adapted to display parking related messages.

27. A single space electronic parking meter as claimed in claim 26 wherein the microcontroller includes paging means for controlling the activation of the parking related messages on the LCD's.

28. A single space electronic parking meter as claimed in claim 27 wherein the LCD's comprise a front LCD and a back LCD having a number of message elements.

29. A single space electronic parking meter as claimed in claim 28 wherein the paging means is adapted to control each message element individually.

30. A single space electronic parking meter as claimed in claim 28 wherein each message element is individually controlled to blink.

31. A single space electronic parking meter as claimed in claim 28 wherein the output interface includes a backlight positioned relative to the front LCD to enhance the visibility of the parking related messages.

32. A single space electronic parking meter as claimed in claim 22 wherein the output interface comprises one or more LED's adapted to indicate status of the parking meter, and wherein the microcontroller includes means for controlling the LED's to blink at a predetermined rate for a variable duration.

33. A single space electronic parking meter as claimed in claim 22 wherein the parking meter includes a real time clock, wherein the microcontroller includes means for applying a calibration factor to the clock to minimize error at a predetermined temperature and wherein the microcontroller includes means for periodically recalibrating the clock to compensate for temperature variation from the predetermined temperature.

34. A single space electronic parking meter as claimed in claim 33 wherein the real time clock comprises:
a crystal clock having a fixed frequency;
a basic timer coupled to the crystal clock for outputting signals at a frequency lower than the fixed frequency; and
a counter for counting the basic timer signals for providing an output signal equivalent to a period of time to the real time clock to increment the real time clock.

35. A single space electronic parking meter as claimed in claim 22 wherein the microcontroller includes a temperature sensor for sensing the environment of the microcontroller.

36. A method of controlling an electronic parking meter operated by a battery pack wherein the battery pack has a nominal low voltage threshold, comprising:
a. periodically sensing temperature of the battery environment at a first predetermined rate;
b. adjusting the nominal low voltage threshold as a function of the temperature;
c. periodically sensing the real time voltage of the battery pack at a second predetermined rate;
d. comparing real time voltages of the battery pack to the adjusted low voltage thresholds in real time; and
e) providing a battery low voltage signal when the real time voltage of the battery is below the adjusted low voltage threshold over a predetermined number of comparisons.

37. A method of controlling a battery operated electronic parking meter as claimed in claim 36 wherein the second predetermined rate is substantially equal to the first predetermined rate.

38. A method of controlling a battery operated electronic parking meter as claimed in claim 36 wherein the nominal low voltage threshold is adjusted upward with a decrease in temperature and adjusted downward with an increase in temperature.

39. A method of replacing a battery pack having a predetermined voltage in a battery operated electronic parking meter having a flyback switcher power supply and a meter operating software comprising:
a) removing the battery pack to be replaced from the meter;
b) connecting a further battery pack to the meter;
c) measuring the voltage of the further battery pack; and
d) comparing the voltage of the further battery pack to the predetermined voltage.

40. A method of replacing a battery pack as claimed in claim 39 comprising the step of downloading operating parameters to the electronic parking meter corresponding to the further battery pack when the voltage of the further battery pack is not equal to the predetermined voltage.

41. A method of controlling an electronic parking meter comprising:
a. maintaining the parking meter in a sleep mode as a default state;
b. placing the parking meter in a schedule wake-up mode at a predetermined frequency for a predetermined short period of time to carry-out maintenance functions; and
c. placing the parking meter in an event wake-up mode for the time required. to process major events as they occur.

42. A method of controlling an electronic parking meter as claimed in claim 41, wherein step a. includes:
a.1. generating a basic timer signal having a predetermined frequency.

43. A method of controlling an electronic parking meter as claimed in claim 42, wherein step a. includes:
a.2. displaying parking related messages.

44. A method of controlling an electronic parking meter as claimed in claim 43, wherein step b. includes:
b.1. applying the basic timer signal to a parking meter processor for placing the parking meter in the schedule wake-up mode.

45. A method of controlling an electronic parking meter as claimed in claim 44, wherein step b. includes:
b.2. applying the basic timer signal to a real time clock to increment the clock; and
b.3. adjusting the incrementation of the clock by a temperature variation factor.

46. A method of controlling an electronic parking meter as claimed in claims 42 wherein the basic timer signal frequency is in the order of 64 hz.

47. A method of controlling an electronic parking meter as claimed in claim 45, wherein step b. includes:
b.4. assuring the proper status of displayed parking related messages; and
b.5. polling payment devices.

48. A method of controlling an electronic parking meter as claimed in claim 47, wherein payment devices are polled at the basic timer signal frequency.

49. A method of controlling an electronic parking meter as claimed in claim 47, wherein step b. includes:
b.6. polling communications ports.

50. A method of controlling an electronic parking meter as claimed in claim 49, wherein communications ports are polled at a frequency in the order of 1 hz.

51. A method of controlling an electronic parking meter as claimed in claim 43, wherein step b. includes:
b.7. measuring the voltage of a battery pack in a power supply for the parking meter;
b.8. comparing the battery pack voltage to a low battery threshold voltage for the power pack;

52. A method of controlling an electronic parking meter as claimed in claim 51, wherein step b.8. includes:
b.8.i. measuring the temperature of the battery pack environment; and
b.8.ii. adjusting the low battery threshold voltage as a function of the temperature.

53. A method of controlling an electronic parking meter as claimed in claim 43, wherein step c. includes:
c.1. receiving an interrupt signal from a major event device in the parking meter;
c.2. processing a request from the major event device.

54. A method of controlling an electronic parking meter as claimed in claim 53, wherein the major event device comprises at least one of the following: a coin chute, a card reader, a communications port.
